(19) United States
(12) Patent Application Publication
(10) Pub. No.: US 2022/0400086 A1
(43) Pub. Date: Dec. 15, 2022

(54) SYSTEMS AND METHODS FOR MULTICAST RESOURCE MANAGEMENT USING AI MODEL OF ANALYTICS AND CLOUD BASED CENTRALIZED CONTROLLER

(71) Applicant: HEWLETT PACKARD ENTERPRISE DEVELOPMENT LP, Houston, TX (US)

(72) Inventors: Tathagata Nandy, Bangalore (IN); Chethan Chavadibagilu Radhakrishnabhat, Bangalore (IN); Srinidhi Hari Prasad, Bangalore (IN)

(21) Appl. No.: 17/346,933

(22) Filed: Jun. 14, 2021

(51) Int. Cl. H04L 12/927; H04L 12/813; H04L 12/24; H04L 12/18

(52) U.S. Cl. CPC H04L 47/805; H04L 47/20; H04L 47/801; H04L 41/147; H04L 41/16; H04L 12/1886; H04L 12/185

(57) ABSTRACT

Systems are methods are described for predicting and forecasting a resource utilization on network device, particularly for handling multicast flows, by monitoring past resource consumption patterns. A system can include a plurality of multicast clients coupled to a network; and a network device coupled to the network. The network device may be a switch or a router that directs multicast traffic to the plurality of multicast clients. The network device can include a flow prediction controller that determines one or more real-time predictions relating to a demand of the network based on an analysis of an artificial intelligence (AI) forecasting model, such as an Autoregressive Integrated Moving Average (ARIMA) model. Also, the network device can include a resource optimizer that performs a resource management action that optimizes the resources of the network device based on the one or more real-time predictions of the demand of the network and a policy.

### DESCRIPTION OF RELATED ART

A robust, disruption free network with assured quality of service (QoS) is a key performance criterion in any enterprise network. With the increase in edge devices and cloud services, traffic seen by networking devices is increasing significantly. It is critical that network devices, such as routers, can handle this increasing load and dynamically adapt to the new demands. However, hardware resources in such network devices are limited, so these resources need to be managed efficiently. While many operations can be handled in software, utilizing a solely software approach may increase latency, for example, by taking additional time and CPU cycles. Thus, it may be desirable to implement a solution which manages both the hardware and software resources that are available at the network resource in order to adapt dynamically to the future demands.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate the reader's understanding of various embodiments and shall not be considered limiting of the breadth, scope, or applicability of the present disclosure. It should be noted that for clarity and ease of illustration these drawings are not necessarily made to scale.

FIG. 1 illustrates an example networking environment in which the disclosed multicast resource management system may be implemented.

FIG. 2A is a conceptual diagram illustrating an example function of a flow prediction controller shown in the multicast resource management system of FIG. 1, in accordance with the disclosure.

FIG. 2B is a table illustrating examples of the monitored data sets utilized by the flow prediction controller shown in FIG. 2A, in accordance with the disclosure.

FIG. 2C is a conceptual diagram illustrating an example function of a resource optimizer shown in the multicast resource management system of FIG. 1, in accordance with the disclosure.

FIG. 2D is a table illustrating examples of the resource allocation policy and the resource management actions implemented by the resource optimizer shown in FIG. 2C, in accordance with the disclosure.

FIG. 3 is an operational flow diagram illustrating an example method for implementing multicast resource management techniques, in accordance with the disclosure.

FIG. 4 is a block diagram of an example computing component or device for implementing the disclosed multicast resource management techniques, in accordance with the disclosure.

The figures are not intended to be exhaustive or to limit various embodiments to the precise form disclosed. It should be understood that various embodiments can be practiced with modification and alteration.

### DETAILED DESCRIPTION

An example system consistent with this disclosure forecasts and predicts a resource utilization for a network device, such as a router, by monitoring past resource consumption patterns. In certain examples, such resource utilization is forecast and predicted particularly for multicast flows within the network. An Artificial Intelligence (AI) forecasting model, such as an Autoregressive Integrated Moving Average (ARIMA) model, may be leveraged to perform real-time analysis, forecasting, and predicting of the future demands on the network. Based on the real-time predictions, the network device can efficiently reorganize its limited resources, optimizing its performance. Furthermore, the system can perform these adaptations to optimally meet the predicted demands without disrupting the existing multicast flows on the network, thereby ensuring that communication on the network remains reliable and uninterrupted. According to some embodiments, elements that are configured for performing the disclosed multicast resource management can be embedded in a network device, for example incorporating a micro-service (executing some multicast resource management aspects) in the switch software. Furthermore, some elements that are configured for performing the disclosed multicast resource management may be implemented within a cloud-based service, for instance a component of a cloud-based management service which handles policy provisioning aspects of multicast resource management.

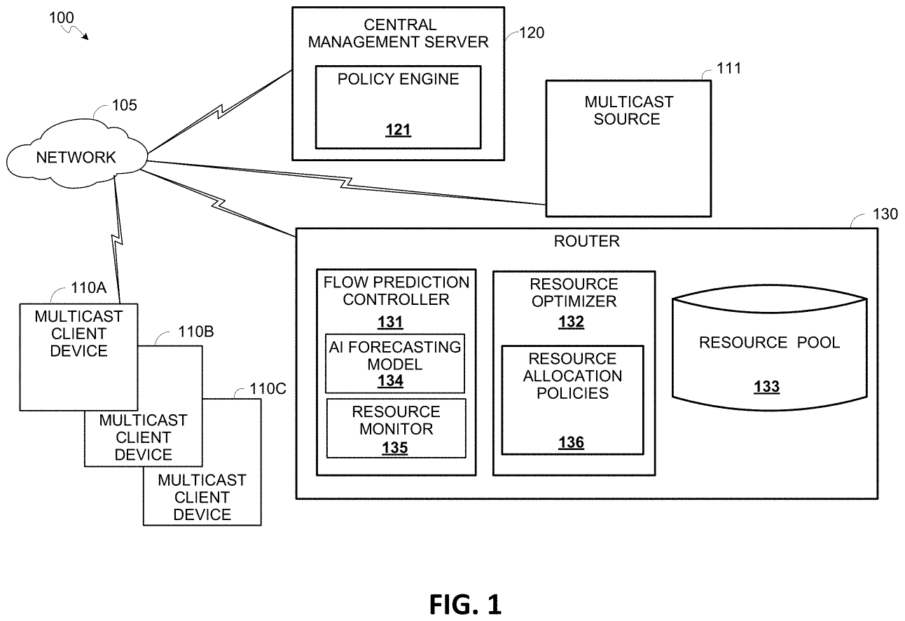

FIG. 1 depicts an example of a networking environment including a multicast resource management system 100. The multicast resource management system 100 is shown to include a plurality of multicast client devices 110A-110C and a multicast source 111 that are communicatively coupled to a router 130 via the communication network 105. Additionally, the router 130 can be communicatively coupled with a central management server 120 via the communication network 105. The communication network 105 may be a public Wide Area Network (e.g., Internet) or a private network (e.g., Local Area Network (LAN), Intranet, Ethernet, etc.).

The central management server 120 can be implemented as a cloud-based network management solution that enables cloud-based network monitoring and control. As seen in FIG. 1, the central management server 120 can include a policy engine 121. According to the embodiments, the policy engine 121 includes: 1) policies that define the data which is monitored and collected in order to be ultimately utilized by an artificial intelligence (AI) forecasting model 134 (implemented at the router 130) to determine predictions of multicast flows; and 2) policies that dictate the resource management actions performed based on the determined predictions of multicast flows. The central management server 120 can push policies from the policy engine 121 to the router 130, in a manner that enables the router 130 to execute monitoring of resources and optimizing these resources.

The networking environment of FIG. 1 can be a network where multicast traffic is transmitted for various multimedia applications. As referred to herein, multicast (or multipoint) communication involves communication from one to many hosts, or communication originating from many hosts that is destined for many other hosts. Examples of multimedia applications that may utilize multicast communication includes, LAN TV, desktop conferencing, and collaborative computing. In such applications that employ multicasting, a multicast protocol, such as Internet Group Management Protocol (IGMP), can be configured on the hosts, and multicast traffic is generated by one or more servers (inside or outside of the local network), shown in FIG. 1 as multicast source 111. Network devices, such as router 130, in the network (that support the multicast protocol) can then be configured to direct the multicast traffic to the appropriate ports where needed. For example, the multicast client devices 110A-110C may be resource consumers that are running multimedia applications that include daemons handling multicast protocols, such as Protocol Independent Multicast Sparse-Mode (PIM-SM), Protocol Independent Multicast Dense-Mode (PIM-DM), IGMP, and Multicast Listener Discovery (MLD). The multicast source 111 can be a network device, such as a server, that is generating the multicast traffic and subsequently sending that multicast traffic onto the network 105 to be ultimately received by the intended destinations, namely the multicast client devices 110A-110C in this example. As a result, the router 130 can receive multicast traffic from the multicast source 111. The multicast source 111 can also employ a multicasting protocol, such IGMP, which further allows the router 130 to be aware that the traffic it is receiving from the multicast source 111 is multicast traffic and which hosts the multicast traffic should be forward to. Accordingly, multicast client devices 110A-110C may be communicating multicast traffic via the communications network 105. The client devices 110A-110C can be implemented as various computer devices, such as a mobile device, laptop, smartphone, tablet, desktop computer, digital audio player, and the like. However, it should be appreciated that the client devices 110A-110C may be other forms of computer devices.

The router 130 can be configured to handle the routing of multicast traffic to and/or from the multicast client devices 110A-110C. For example, during use of these multimedia applications at the respective multicast client devices 110A-110C, the router 130 can direct the associated multicast traffic from the multicast source 111 to the multicast clients 110A-110C. However, as alluded to above, as the multicast traffic significantly increases on the network (e.g., as a result of more clients or more applications utilizing multicasting) it becomes increasingly more critical that the router 130 can appropriately handle the increased loads and has the capability to dynamically adapt to the demands on the network. For example, key resources of the router 130 that may be consumed by the multicast protocols can include, but are not limited to: 1) Internet Protocol (IP) Multicast table entries in the router's Application Specific Integrated Circuit (ASIC) to program bridge and route entries; and 2) Central Processing Unit (CPU) cycles to handle unknown multicast data, and register packets. Even further, attempting to dynamically adapting the router's resources in order to meet the demands of multicast traffic is particularly difficult, as the demands are continuously changing on a network. Often, the demands relating to multicasting on the network change extremely quickly, essentially in real-time.

In order to address these challenges, the disclosed embodiments implement a network device that is distinctly configured to not only predict future demands on the network for multicast traffic in real-time, but also to dynamically adjust management and utilization of its resources in a manner that is optimal to meet the demands on the network (based on the predictions). According to the embodiments, the router 130 can include several elements that support the distinct capabilities to achieve multicast resource management, including: data monitoring, forecast modeling, and real-time prediction of multicast flows. In the example of FIG. 1, the router 130 is configured to include: a flow prediction controller 131, where the flow prediction controller 131 comprises an artificial intelligence (AI) model 134 and a resource monitor 135; a resource optimizer 132, where the resource optimizer 132 includes resource allocation policies 136; and a resource pool 133. The resource pool 133 can be configured to support resource pooling capabilities at the router 130 to generally improve throughput by sharing and reuse of expensive resources, as known in the art.

As illustrated, the flow prediction controller 131 resides on the router 130 and is configured to monitor resource consumptions and demands on the network, for example monitoring the multicast traffic and other data that is communication from the multicast client devices 110A-110C. The flow prediction controller 131 can use this monitored data to train the AI forecasting model 134, such that AI algorithms can predict the future resource demands.

Additionally, the router 130 is configured to include a resource optimizer 132. The resource optimizer 132 is employed to optimize and re-organize critical resources of the router 130, in order to accommodate new flows without disturbing existing flows. As alluded to above, the disclosed embodiments realizes advantages over other resource management approaches by achieving this optimization without disrupting the existing multicast flows, and does not trade-off increased optimization by reducing reliability (e.g., increased dropped packets, greater multicast traffic latency, lost or interrupted multicast flows). Thus, the router 130 can dynamically adjust management of its resource and direct multicast traffic amongst the multicast clients 110A-110C in a manner that is optimized for the current and predicted future demands of these devices on the network without disrupting other multicast flows on the network.

It should be understood that the disclosed embodiments are described with respect to a router 130 for purposes of illustration. The description is not intended to be limited to the configuration of FIG. 1, thus the elements and functions of the disclosed multicast resource management system 100 can be implemented on other types of network devices, such as gateways, switches, servers, and the like, including on the central management server 120.

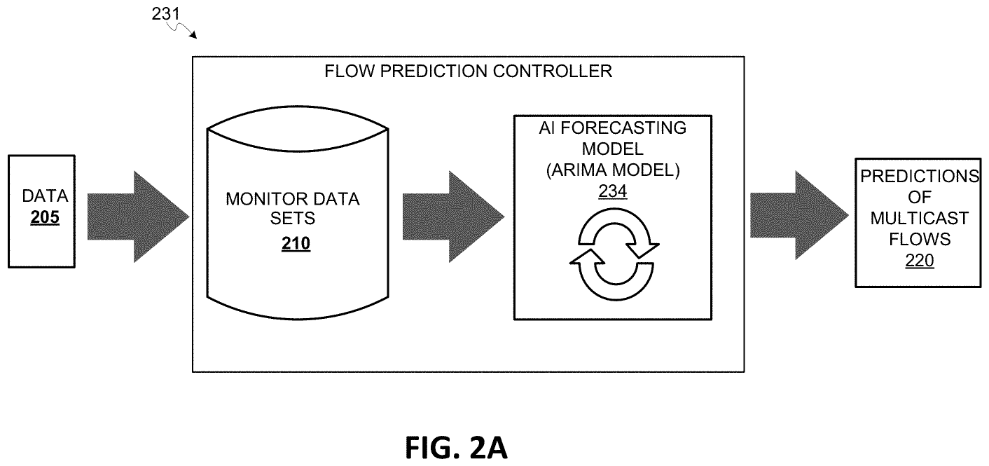

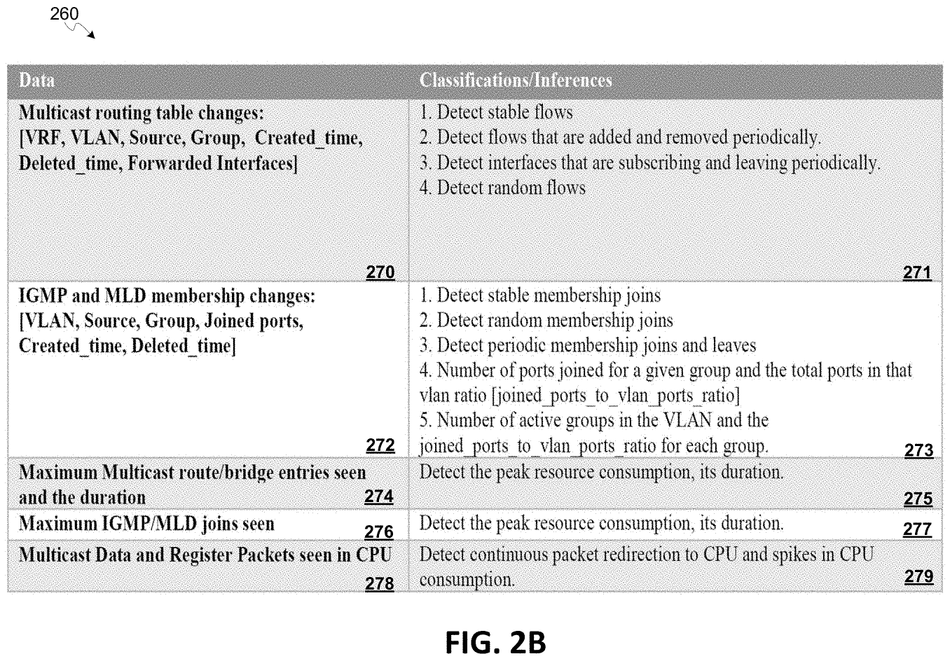

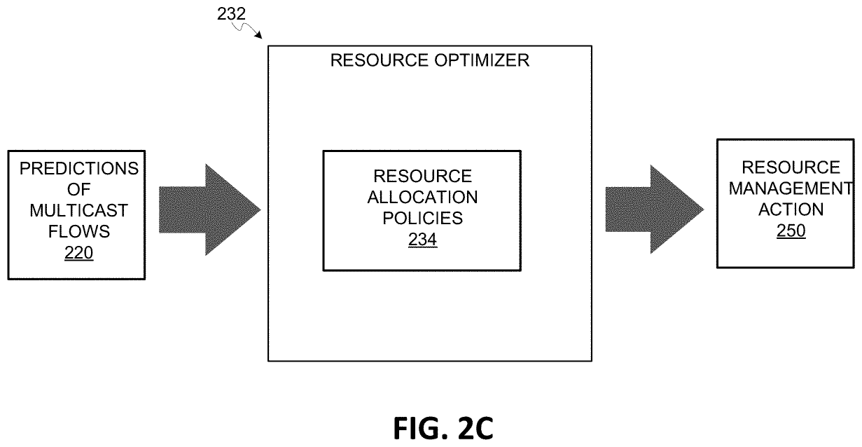

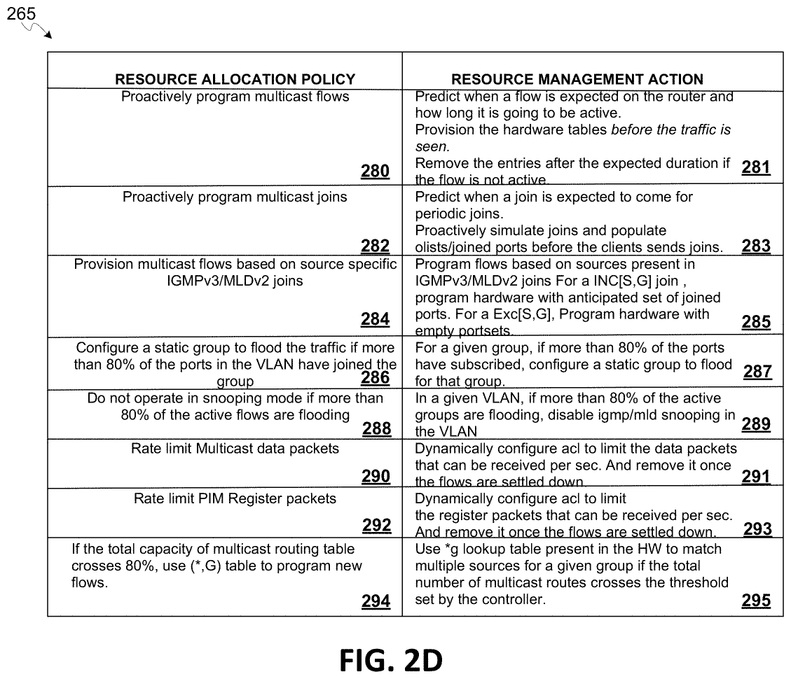

Referring now to FIG. 2A, a conceptual diagram of the function of the flow prediction controller 231 is illustrated. The flow prediction controller 231 can be implemented as a hardware component, a software component, or a combination thereof, integrated on a network device communicating multicast traffic, such as a router (shown in FIG. 1). For example, the functionality that is diagramed in FIG. 2A may be implemented by machine-readable instructions stored on a memory and executed by one or more processor(s) of the flow prediction controller 231 and/or the network device.

A key function of the flow prediction controller 231 is data monitoring. As illustrated, data 205 can be received by the flow prediction controller 231 while monitoring the network for traffic and indications of demands. Table 260, shown in FIG. 2B, indicates the data sets monitored and the inferences and classifications that can be made by monitoring them over a period of time.

As shown in table 260, data 270 can include multicast routing table changes, and the corresponding classification/inferences 271 can include detecting the stable flows, detecting flows that are added and removed periodically, detecting interfaces that are subscribing and leaving periodically, and detecting random flows. Data 272 can include IGMP and MLD membership changes, and the corresponding classification/inference 273 can include detecting stable membership joins, detecting random membership joins, detecting periodic membership joins and leaves, determining the number of ports joined for a given group and the total ports in the VLAN ratio, and determining the number of active groups in the VLAN and a “joined_ports_to_VLAN_ports_ratio” for each group. Also, data 274 can include maximum multicast route/bridge entries seen and the duration, and the corresponding classification/inference 275 can include detecting the peak resource consumption and its duration. Data 276 can include the maximum IGMP/MLD joins seen, and the corresponding classification/inference 277 can include detecting the peak resource consumption and its duration. Additionally, data 278 can include multicast data and register packets seen in the CPU, and the corresponding classification/inference 279 can include detecting continuous packet redirection to the CPU and spikes in the CPU consumption. In some embodiments, the table 260 can be stored in a memory of flow prediction controller 231, where the table 260 is employed to govern the data that is analyzed and actions of the flow prediction controller 231 during data monitoring.

In order to proactively manage the multicast resources, real-time prediction of the multicast flows is another key function that is performed by the flow prediction controller 231 shown in FIG. 2A. As previously described in reference to FIG. 1, the AI forecasting model 234 can be implemented on the flow prediction controller 231. AI techniques (i.e. machine learning) often involve building (i.e. generating and training) a model based on sample data, known as “training data” in order to make predictions or decisions. AI models are increasingly being deployed to make predictions over unstructured data, and these predictions are subsequently used to take actions in real-world systems. Particularly in the realm of networking, AI models can predict network traffic accurately. The quality and accuracy of AI models is of paramount concern, with respect to the accuracy and confidence of the resulting predictions. Thus, according to some embodiments, the AI forecasting model 234 is particularly implemented as an ARIMA model which can provide improved accuracy and reliable results. As background, ARIMA refers to a class of models that models a time series of data based on past values (or lags) and a moving average of the data (lagged forecast errors), so that equation can be used to forecast future values. In ARIMA, models are fitted to time series data either to better understand the data or to predict future points in the series, which supports forecasting.

The AI forecasting model 234 analyzes the data 205 obtained from data monitoring, for forecasting and predicting the multicast flows and their resource utilization. Further analysis of the predictions is also key to improving the performance of the AI forecasting model 234. Accordingly, in some embodiments, the flow prediction controller 231 can also perform a prediction performance analysis, for instance using a Root Mean Square Error (RMSE) metric, in order to determine a quantitative indication of performance for the AI forecasting model 234.

As previously described, the flow prediction controller 231 collects and prepares data 205. The data samples that are required for modelling are collected at regular time intervals, as specified by the policy engine. Examples of features that are collected from the data 205 are listed in table 260 of FIG. 2B (column ‘Data’ column), as previously described in detail in reference to FIG. 2B. The data 205 that is collected, or otherwise received, by the flow prediction controller 231 can be divided into “training” data and “testing” data. As an example, the flow prediction controller 231 may divide the collected data 205 into 80% training and 20% testing to be used by the AI forecasting model 234. As a result, the flow prediction controller 231 can utilize this data to perform generation of the AI forecasting model 234 and testing of the AI forecasting model 234. For example, the AI forecasting model 234, which is an ARIMA model in this case, is fit to the training set (or the training data), and the parameters (p,q,d) are varied so that a best fit is achieved for the training data. In an example, the d parameter is the level of differencing, the p parameter is the autoregressive order, and q parameter is the moving average order. The testing data, which is held out from the training data, is tested on the ARIMA model after it has been built, in order to check the accuracy of the model. Alternatively, in some embodiments, the AI forecasting model 234 can be deployed to the network device as part of the flow prediction controller 231, after it is already generated and tested. As illustrated in FIG. 2A, the AI forecasting model 234 can be applied to the collected data 205 to accomplish forecasting and predicting in real-time, in manner that ultimately allows the multicast resources to be dynamically adjusted and optimized as the demands change. As seen, the AI forecasting model 234 can produce predictions of multicast flows 220 that can be communicated to and subsequently employed by other disclosed components of the network device, namely the resource optimizer that is shown in FIG. 2C.

In FIG. 2C, a conceptual diagram of the function of the resource optimizer 232 is illustrated. The resource optimizer 232 can be implemented as a hardware component, a software component, or a combination thereof, integrated on a network device communicating multicast traffic, such as a router (shown in FIG. 1). The functionality that is diagramed in FIG. 2C may be implemented by machine-readable instructions stored on a memory and executed by one or more processor(s) of the resource optimizer 232 and/or the network device.

The resource optimizer 232 is configured to handle resource allocations and re-organization of key resources of the network device in order to meet higher (or dynamically changing) demands, based on the real-time prediction. As seen, the resource optimizer 232 can receive predictions of multicast flows 220 that have been previously generated by the flow prediction controller (shown in FIG. 2A). Further, the resource optimizer 232 can be configured to take resource management actions based on these predictions. The table 265 shown in FIG. 2D illustrates examples of the resource management actions that can be taken by the resource optimizer engine 232. The table 265 shows the particular resource management actions that can be taken corresponding to the resource allocation policies 234 installed on the resource optimizer 232 by the controller, and the predictions of multicast flows 220 (computer by the flow prediction engine). FIG. 2D shows the resource allocation policy 280 can include proactively programming multicast flows, and the corresponding resource management action 281 can include predicting when a flow is expected on the network device and a duration the flow will be active, provisioning the hardware tables before the traffic is seen, and removing entries after an expected duration if the flow is not active. The resource allocation policy 282 can include proactively programming multicast joins, and the corresponding resource management action 283 can include predicting when a join is expected for periodic joins, proactively simulating joins, and populating O-Lists and/or joined ports before the client sends the requests for the joins. The resource allocation policy 284 can include provisioning multicast flows based on source specification IGMPv3/MLDv2 joins, and the corresponding resource management action 285 can include programming flows based on sources present in IGMPv3/MLDv2 joins, programming hardware with anticipated set of joined ports, and programming hardware with empty port sets. Another resource allocation policy 286 can include configuring a static group to flood traffic (e.g., if more than 80% of the active flows are flooding), and the corresponding resource management action 287 can include configuring a static group to flood for a given group (e.g., if more than 80% of the active groups are flooding). A resource allocation policy 288 can include preventing the operation of snooping mode (e.g., if more than 80% of the active flows are flooding), and the corresponding resource allocation policy 289 can include disabling the IGMP/MLD snooping in the VLAN (e.g., if the more than 80% of the active groups are flooding). Another resource allocation policy 290 can include rate limiting the multicast data packets, and the corresponding resource management action 291 can include dynamically configuring an access control list (ACL) to limit the data packets that can be received per second. A resource allocation policy 292 can include rate limiting the PIM register packets, and the corresponding resource management action 293 can include dynamically configuring the ACL to limit the register packets that can be received per second. Yet another resource allocation policy 294 can include programing (Start, G) in the table for new flows such that space of the table on the network device is optimized (e.g., if the total capacity of multicast routing table crosses 80%), and the corresponding resource management action 295 includes using (Start, G) lookup table in the hardware to match multiple sources for a given group (e.g., if the total number of multicast routes crosses the threshold set by the controller). It should be appreciated that table 265 is not intended to be limiting, and the resource optimizer 232 (including the resource allocation policies, and the resource management actions) have the flexibility to be programmable in order to reach specific optimization results for differing network environments, as deemed necessary and/or appropriate.

FIG. 2C illustrates that the resource optimizer engine 232 can produce the resource management actions 250 as an output. Thereafter, the resource management actions 250 can be executed by the one or more processors of the resource optimizer 232 or the network device. Accordingly, the network device, as disclosed by the embodiments, provides an enhancement over other network devices by achieving resource allocation that is optimized for multicasting, that is based on dynamic analytics of demand predictions.

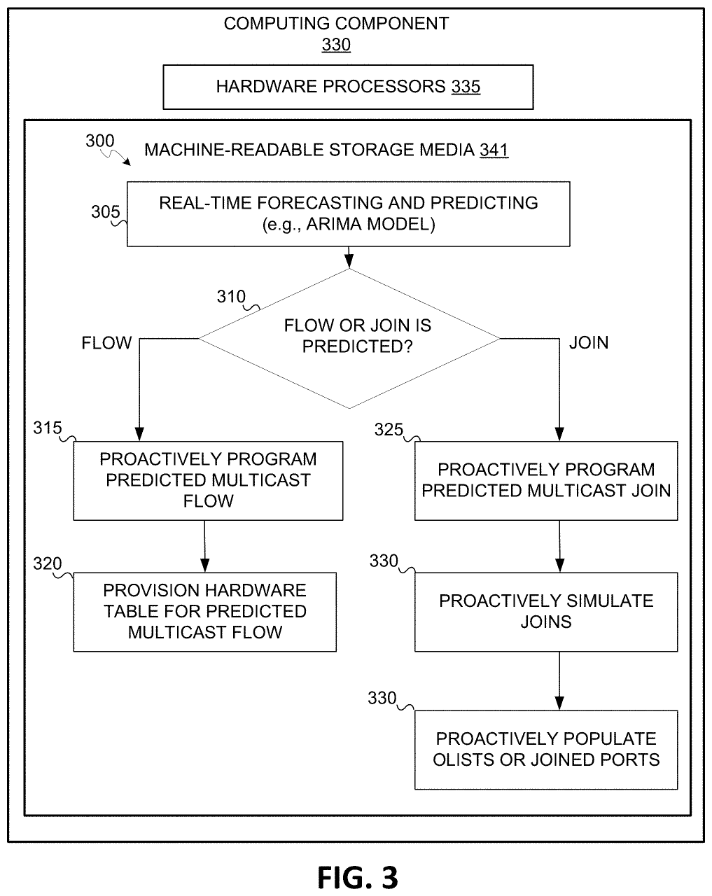

FIG. 3 illustrates a flow chart of a process 300 for implementing the disclosed multicast resource management techniques. Generally, process 300 implements resource management actions that can be performed in response to real-time predictions that a multicast flow is expected on the network device, or predictions that a multicast join is expected on the network device. Furthermore, FIG. 3 shows process 300 as a series of executable operations stored on a machine-readable storage medium 304 performed by hardware processors 302, which can be the main processor of a computing component 300. For example, the computing component 300 can be a network device, such as a router described at least in reference to FIG. 1. In operation, hardware processors 302 execute the operations of process 300, thereby implementing the disclosed multicast resource management techniques.

In the example, the process 300 begins at operation 305 where real-time forecasts and predictions of a resource utilization for multicast flows on a network device are derived. As described previously in detail, these predictions can be based on predictions relating to future demands on the network, and can involve applying an ARIMA model to the data that is collected from the network communicating multicast traffic, in order to generate a prediction as a result.

Thereafter, at operation 310, a conditional check is performed to determine whether the prediction indicates that a multicast flow is expected on the network device, or that the prediction indicates that a multicast join is expected. As referred to herein, a multicast join can refer to a message transmitted in order for a client to join a multicast group. In order to join a multicast group, a host sends a join message, for instance using IGMP, to its first-hop router. Multicast groups are identified by a single class D IP address (e.g., in the range 224.0.0.0 to 239.255.255.255). In this way, messages destined for a multicast group are addressed to the appropriate IP address, similar to other non-multicast group message. In the case where the check determines that a multicast flow is predicted (shown as “FLOW” in FIG. 3), then the process 300 continues to operation 315.

At operation 315, based on the predicted multicast flow, resource utilization for one or more multicast flows, based on the predicted multicast flow, is proactively programmed at the network device. In some cases, the prediction of a multicast flow also determines an expected duration that the predicted multicast flow is foreseen to be active. Proactively programming can involve programming hardware and software resources of the network device for one or more multicast flows, such as IP multicast table entries, CPU cycles, and the like. Furthermore, programming resource utilization for the one or more multicast flows is performed prior to the multicast traffic associated with the predicted multicast flow arriving at the network device. By proactively programming the network device's resources for one or more multicast flows (based on the predicted multicast flow) before the actual multicast traffic arrives at the network device, various advantages can be realized. For example, by proactively programming resources for the one or more multicast flows in operation 315, unknown multicast miss punting to the CPU can be avoided, and CPU cycles may be saved. This resource management action of operation 315 can also enable faster convergence of new multicast flows.

Next, at operation 320, the hardware tables are provisioned for the one or more flows (based on the predicted multicast flow). As alluded to above, the hardware tables are provisioned as a predictive resource management action, being completed before the multicast traffic actually arrives at the network device. In some cases, operation 320 can involve removing any hardware table entries that have been provisioned for a predicted flow after the expected duration, if the flow is not active.

Referring back to operation 310, in the case where the conditional check determines that a join is predicted (shown as “JOIN” in FIG. 3), then the process 300 can continue to operation 325.

At operation 325, the resource utilization for one or more multicast joins, based on the predicted multicast join, is proactively programmed at the network device. In other words, network resources are proactively programmed for multicast joins, when a multicast join is predicted based on the network demands. According to the embodiments, the resources for the network device are proactively programmed before clients send a multicast join. This resource management action of operation 325 will allow a faster response to the new clients. Next, at operation 330, simulating multicast joins can be proactively performed. Thereafter, at operation 335, o-lists or joined ports can be proactively populated. Accordingly, the resources of the network device are dynamically allocated in a manner that is optimized for a multicast join, thereby efficiently handling new multicast clients on the network.

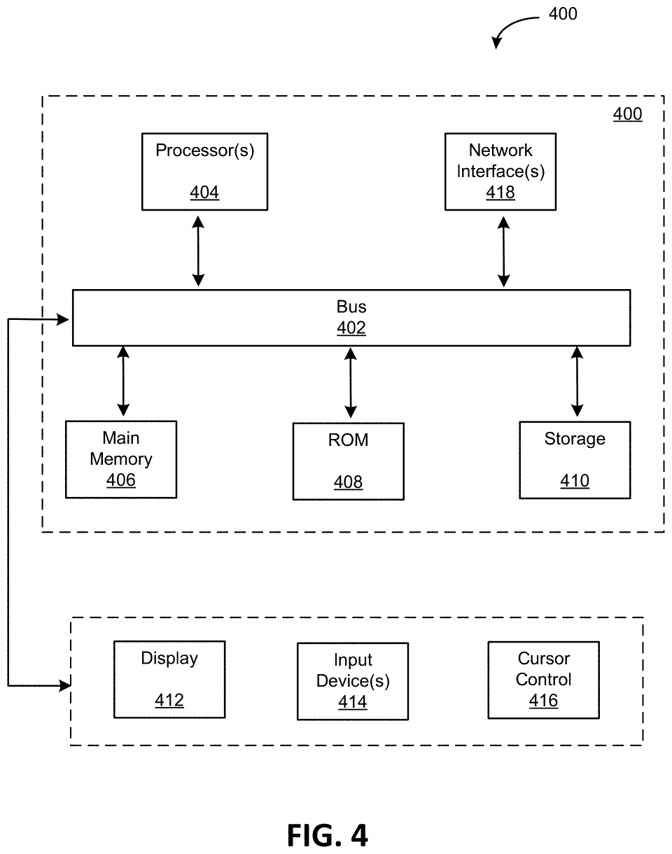

FIG. 4 depicts a block diagram of an example computer system 400 in which the multicast resource management techniques as disclosed herein may be implemented. For example, the computer system 400 may be a networking device, such as a router (shown FIG. 1), as described in detail above. The computer system 400 includes a fabric 502 or other communication mechanism for communicating information, one or more hardware processors 404 coupled with fabric 402 for processing information. Hardware processor(s) 404 may be, for example, one or more general purpose microprocessors.

The computer system 400 also includes a main memory 406, such as a random-access memory (RAM), cache and/or other dynamic storage devices, coupled to fabric 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

The computer system 400 further includes storage devices 410 such as a read only memory (ROM) or other static storage device coupled to fabric 402 for storing static information and instructions for processor 404. A storage device 410, such as a magnetic disk, optical disk, or USB thumb drive (Flash drive), etc., is provided and coupled to fabric 402 for storing information and instructions.

The computer system 400 may be coupled via fabric 402 to a display 412, such as a liquid crystal display (LCD) (or touch screen), for displaying information to a computer user. An input device 414, including alphanumeric and other keys, is coupled to fabric 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 406. Such instructions may be read into main memory 406 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 400.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a plurality of multicast clients coupled to a network; and
a network device directing multicast traffic to the plurality of multicast clients via the network, and the network device comprises:
a flow prediction controller determining one or more real-time predictions relating to a demand of the network based on an analysis of an artificial intelligence (AI) forecasting model; and
a resource optimizer performing a resource management action based on the one or more real-time predictions and a determined policy, wherein the resource action is optimized for the one or more real-time predictions of the demand of the network.

2. The system of claim 1, wherein the AI forecasting model is an Autoregressive Integrated Moving Average (ARIMA) model.

3. The system of claim 2, wherein the flow prediction controller comprises:
a resource monitor monitoring the multicast traffic on the network and receiving data based on the monitored multicast traffic on the network; and
the AI forecasting model analyzing the received data.

4. The system of claim 3, wherein the ARIMA model is generated and tested using the received data.

5. The system of claim 3, wherein the resource optimizer comprises one or more resource allocation policies, and the determined policy is from the one or more resource allocation policies.

6. The system of claim 5, further comprising a central management server coupled to the network.

7. The system of claim 6, wherein the one or more resource allocation policies are installed on the resource optimizer from the central management server.

8. The system of claim 4, wherein the flow prediction comprises:
monitored data sets including data monitored by the resource monitor and classifications determined by monitoring the data over time.

9. The system of claim 3, wherein the AI model outputs the one or more real-time predictions.

10. The system of claim 1, wherein the resource management action comprises proactively programming multicast flows such that a load running on a central processing unit (CPU) of the network device is reduced.

11. The system of claim 1, wherein the resource management action comprises provisioning multicast flows based on a source specific join such that a latency associated with the network device is reduced.

12. The system of claim 1, wherein the resource management action comprises configuring a static group to flood the traffic such that ASIC resources on the network device are optimized.

13. The system of claim 1, wherein the resource management action comprises at least one of:
preventing operating in a snooping mode, rate limiting multicast data packets, rate limiting Protocol Independent Multicast (PIM) Register packets, and programming an entry in a table to program new flows.

14. The system of claim 13, wherein programming the entry comprises programming (Start, G) in the table such that space of the table on the network device is optimized.

15. A non-transitory computer-readable storage medium having stored thereon executable computer program instructions that, when executed by one or more processors, cause the one or more processors to perform operations comprising:
predicting, in real-time, a resource utilization for multicast flows on a network device;
determining whether a multicast flow is predicted on the network device or a multicast join is predicted on the network device based on the predicting;
in response to determining that a multicast flow is predicted on the network device, proactively programming resource utilization for one or more multicast flows on the network device.

16. The non-transitory computer-readable storage of claim 15, wherein proactively programming resource utilization for one or more multicast flows is performed prior to multicast traffic associated with the predicted multicast flow arriving at the network device.

17. The non-transitory computer-readable storage of claim 15, programmed to perform further operations comprising:
provisioning a hardware table of the network device for the predicted multicast flow.

18. The non-transitory computer-readable storage of claim 17, wherein proactively programming resource utilization for one or more multicast flows comprises:
determining an expected duration that the predicted multicast flow is predicted to be active; and
upon determining that the predicted multicast flow is not active after the expected duration has expired, removing one or more entries of the provisioned hardware table.

19. The non-transitory computer-readable storage of claim 15, programmed to perform further operations comprising:
in response to determining that a multicast join is predicted on the network device, proactively programming resource utilization for one or more multicast joins on the network device;
proactively simulating the one or more multicast joins on the network device; and
proactively populating o-lists or joined lists ports, wherein the populating is performed prior to a client sending a request associated with the predicted multicast join.

20. A method comprising:
determining, by a central management server, one or more real-time predictions relating to a demand of a network based on an analysis of an artificial intelligence (AI) forecasting model; and
determining, by the centralized management server, a resource management action based on the one or more real-time predictions and a policy, wherein the resource action is optimized for the one or more real-time predictions of the demand of the network.
